(19) United States
(12) Patent Application Publication
(10) Pub. No.: US 2013/0066647 A1
(43) Pub. Date: Mar. 14, 2013

(54) SYSTEMS AND METHODS FOR SURGICAL SUPPORT AND MANAGEMENT

(71) Applicants: Matthew J. Andrie, South Easton, MA (US); Timothy A. Beardsley, Kingston, MA (US); Beth Bissonnette, Hopedale, MA (US); Brett Patrick Knickerbocker, Chelsea, MI (US); Adam LaWare, Medford, MA (US); Bradley Moore, West Vancouver (CA); David O'Brien, Arlington, MA (US); Christopher Rigsby, Providence, RI (US)

(72) Inventors: Matthew J. Andrie, South Easton, MA (US); Timothy A. Beardsley, Kingston, MA (US); Beth Bissonnette, Hopedale, MA (US); Brett Patrick Knickerbocker, Chelsea, MI (US); Adam LaWare, Medford, MA (US); Bradley Moore, West Vancouver (CA); David O'Brien, Arlington, MA (US); Christopher Rigsby, Providence, RI (US)

(73) Assignee: DEPUY SPINE, INC., Raynham, MA (US)

(21) Appl. No.: 13/603,452

(22) Filed: Sep. 5, 2012

Related U.S. Application Data
(60) Provisional application No. 61/532,915, filed on Sep. 9, 2011.

(51) Int. Cl. G06Q 50/22

(52) U.S. Cl. 705/2

(57) ABSTRACT

Systems and methods are disclosed herein that generally provide a new model for surgical support and management. Tasks typically performed in advance of and following a surgery can be performed in an automated and efficiency-optimized manner, particularly in the case of routine or straightforward surgical procedures. In one embodiment, the various parties involved in a surgery can access a surgical support and management system using one or more web pages. The system can perform various tasks associated with the surgical planning, inventory planning, intra-operative support, post-surgery logistics, and billing phases of surgical support and management.

### CROSS-REFERENCE TO RELATED APPLICATIONS

This application claims priority to U.S. Provisional Application No. 61/532,915, filed on Sep. 9, 2011, which is hereby incorporated by reference in its entirety.

### FIELD

The present invention relates to systems and methods for surgical support and management. In particular, the present invention relates to supporting and managing surgeries that involve medical devices (e.g., medical implants and instruments).

### BACKGROUND

A traditional model for supporting and managing surgeries that involve medical devices includes several phases. These phases typically include surgical planning, inventory planning, intra-operative support, post-surgery logistics, and charge capture or billing.

During the surgical planning phase, a surgeon or a staff member at the surgeon's office contacts the hospital where the surgery is to be performed to schedule resources such as operating rooms, equipment, and support staff. The hospital maintains a surgery schedule using a spreadsheet, whiteboard, or internal enterprise resource planning system that includes information such as the type of surgery, the name of the surgeon, the date the surgery is to be performed, and the supply and equipment needs of the surgery. A representative of a medical device company obtains the surgery schedule periodically and, for each surgery that involves a medical device provided by the medical device company, meets with the surgeon to discuss a plan for the surgery.

After establishing a plan for the surgery, the representative orders the various medical devices believed to be necessary for the surgery in the inventory planning phase. The medical devices are shipped from the medical device company or a distributor affiliated therewith to the representative, who is then responsible for providing the medical devices to the hospital for sterilization in advance of the surgery.

Prior to the surgery, the representative is typically relied upon to provide pre-surgery training on any new or modified medical devices or instruments. Such training can include use of hands-on demonstration equipment or review of surgical brochures provided by the medical device manufacturer. The representative is generally responsible for selecting and executing the appropriate training, based on the available supporting materials.

During the surgery itself, the representative is typically present in the operating room, regardless of the complexity of the surgery, to provide technical support to the surgeon and staff. The representative is also present to track consumption of inventory as well as components in need of maintenance or replacement.

After the surgery, the representative ensures that consumed inventory is replenished and that reusable instruments are sterilized and prepared for subsequent use.

Finally, the representative assists hospital staff in completing paperwork that identifies the patient and the inventory consumed. A purchasing group at the hospital reviews the paperwork and transmits it to the medical device company or its distributor. A manual reconciliation process occurs thereafter to determine billing amounts and to trigger inventory replenishment.

There are a number of inefficiencies associated with existing surgery support and management models. For example, a large portion of the representative's time is spent in the operating room during routine procedures in which the representative's assistance is rarely if ever necessary. The representative also spends a significant amount of time completing paperwork and performing surgical planning, inventory management, and other logistical tasks. This time could be better spent supporting more complex surgeries in which representative input is crucial, or generating new business for the medical device company. Furthermore, there are significant costs associated with employing a large staff of representatives.

These models also suffer from a number of inventory-related inefficiencies. For example, in the field of orthopedics, medical device kits are typically assembled so as to provide the necessary implants, tools, and instruments for any of a variety of types of surgery, ranging from the most routine to extraordinarily complex. As a result, many of the medical devices in the kit are not used during routine procedures, and are needlessly transported, inventoried, tracked, processed, sterilized, etc.

Accordingly, there is a need for improved systems and methods for surgical support and management.

### SUMMARY

Systems and methods are disclosed herein that generally provide a new model for surgical support and management. Tasks typically performed in advance of and following a surgery can be performed in an automated and efficiency-optimized manner, particularly in the case of routine or straightforward surgical procedures. In one embodiment, the various parties involved in a surgery can access a surgical support and management system using one or more web pages. The system can perform various tasks associated with the surgical planning, inventory planning, intra-operative support, post-surgery logistics, and billing phases of surgical support and management.

In one aspect, a surgical support and management system is provided that includes a scheduling module that maintains a first database of scheduled surgeries, the scheduling module being configured to schedule a surgery by receiving information indicative of a type of the surgery and a time of the surgery and storing the information in the first database. The system also includes an inventory module that maintains a second database of an inventory of medical devices and determines based on the type of the surgery whether a medical device required for the surgery is available in the inventory. If the medical device required for the surgery is available in the inventory, the inventory module marks the medical device as being reserved for the surgery in the second database.

The scheduling module can also be configured to perform a variety of other tasks, such as displaying one or more of the scheduled surgeries on a calendar, reserving at least one of an operating room, an implant, surgical supplies, surgical equipment, and surgical personnel in response to a surgery being scheduled, and/or sending an electronic message to a hospital staff member in response to a surgery being scheduled.

In one embodiment, the inventory module can maintain the second database in real-time. The inventory module can be configured to display a list of items in the inventory and a current location of each item to a user, and/or to display list entries corresponding to items that are reserved for a surgery with a predetermined mark. The inventory module can also receive inventory quantities and locations from an RFID tracking system. In one embodiment, the inventory module orders the medical device required for the surgery from a supplier if the medical device required for the surgery is not available in the inventory. The inventory module can also automatically order replacements for items of the inventory that are consumed during the surgery and/or that are reserved for a surgery.

The system can also include a planning module configured to receive medical images uploaded by a user and to display the uploaded medical images to other users. The planning module can also permit selection of at least one inventory item desired for the surgery and can communicate with the inventory module to reserve the at least one inventory item. The system can also include a support module accessible from an operating room that is configured to display at least one of instructional information and training information to a user. The support module can include a video conferencing interface and/or can be configured to provide contact information for support personnel to a user.

The system can also include a billing module that generates electronic billing information corresponding to medical devices used during the surgery. The billing module can be configured to transfer the electronic billing information to and from at least one of a purchasing department of a surgical facility, a medical device company, and an electronic patient record.

The system can also include a patient record module configured to store at least one of a lot number, a serial number, and an expiration date associated with the medical device in an electronic patient record.

The system can also include a reporting module that receives information from a user indicating that a particular medical device is at least one of damaged, worn, missing, in need of replacement, in need of maintenance, and in need of sterilization, the reporting module storing the information in the second database.

The system can also include a surgeon profile module that stores profile information for each of a plurality of surgeons. The profile information for each surgeon can include, for each of a plurality of types of surgeries, at least one of the surgeon's preferred operating time, the surgeon's preferred support staff, and the surgeon's preferred medical devices. In one embodiment, the inventory module determines whether sufficient inventory is available based on the surgeon profile information. The scheduling module can include one or more web pages.

In another aspect, a surgical support and management method is provided that includes electronically maintaining a first database of scheduled surgeries and, using at least one computer system, scheduling a surgery by receiving information indicative of a type of the surgery and a time of the surgery and storing the information in the first database. The method also includes electronically maintaining a second database of an inventory of medical devices and, using the at least one computer system, determining based on the type of the surgery whether a medical device required for the surgery is available in the inventory. If the medical device required for the surgery is available in the inventory, the method can include marking the medical device as being reserved for the surgery in the second database using the at least one computer system.

The method can also include displaying one or more of the scheduled surgeries on a calendar, reserving at least one of an operating room, an implant, surgical supplies, surgical equipment, and surgical personnel in response to a surgery being scheduled, and/or sending an electronic message to a hospital staff member in response to a surgery being scheduled.

In one embodiment, the second database can be maintained in real-time. The method can also include displaying a list of items in the inventory and a current location of each item to a user, and/or displaying list entries corresponding to items that are reserved for a surgery with a predetermined mark.

The method can also include receiving inventory quantities and locations from an RFID tracking system, ordering the medical device required for the surgery from a supplier if the medical device required for the surgery is not available in the inventory, ordering replacements for items of the inventory that are consumed during the surgery, and/or ordering replacements for items of the inventory that are reserved for a surgery.

The method can also include receiving medical images uploaded by a user and displaying the uploaded medical images to other users, and/or receiving surgeon implant preference information based on one or more patient images and reserving inventory based on the surgeon implant preference information. The method can also include displaying at least one of instructional information and training information to a user, and/or providing a video conferencing interface to one or more users.

The method can also include providing contact information for support personnel to a user, generating electronic billing information corresponding to medical devices used during the surgery, and/or transferring the electronic billing information to and from at least one of a purchasing department of a surgical facility, a medical device company, and an electronic patient record.

The method can also include storing at least one of a lot number, a serial number, and an expiration date associated with the medical device in an electronic patient record and/or receiving information from a user indicating that a particular medical device is at least one of damaged, worn, missing, in need of replacement, in need of maintenance, and in need of sterilization, and storing the information in the second database.

The method can also include storing profile information for each of a plurality of surgeons, which can include, for each of a plurality of types of surgeries, at least one of the surgeon's preferred operating time, the surgeon's preferred support staff, and the surgeon's preferred medical devices. The method can also include determining whether sufficient inventory is available based on the surgeon profile information. The information indicative of the type of the surgery and the time of the surgery can be received via a web portal.

In another aspect, a method of supplying medical devices is provided that includes electronically receiving surgery information comprising a type of a surgery and a location of the surgery and using at least one processor coupled to a memory to generate a first list of components for inclusion in a kit, the first list being generated based on the type of the surgery. The method also includes assembling the kit and providing the kit to the location of the surgery. The method also includes using the at least one processor to generate a second list of unused components received after the surgery and using the at least one processor to generate billing information comprising charges for components of the kit that are not received after the surgery.

The method can also include electronically receiving surgeon preference information, wherein the first list is generated based on the surgeon preference information. The method can also include using the at least one processor to generate credit information when components of the kit are received after the billing information is generated.

The method can also include processing the unused components of the kit for subsequent use. The kit can be sterilized when provided to the location of the surgery and/or the components can include sterile implants and sterile instruments. In one embodiment, the first list is assembled based on received surgeon preference information. The surgery information can be received via a web portal. Providing the kit to the location of the surgery can include shipping the kit directly to the location of the surgery.

In another aspect, a method of supplying medical devices is provided that includes electronically receiving surgery information comprising a type of a surgery and a location of the surgery and electronically generating a first list of components for inclusion in a kit, the first list being generated based on the type of the surgery. The method also includes assembling the kit and providing the kit to the location of the surgery and electronically generating a second list of unused components received after the surgery. The method also includes electronically generating billing information comprising charges for components of the kit that are not received after the surgery.

In another aspect, a method of supplying medical devices is provided that includes using at least one computer system to receive surgery information comprising a type of a surgery and a location of the surgery and using the at least one computer system to generate a first list of components for inclusion in a kit, the first list being generated based on the type of the surgery. The method also includes assembling the kit and providing the kit to the location of the surgery. The method also includes using the at least one computer system to generate a second list of unused components received after the surgery, and using the at least one computer system to generate billing information comprising charges for components of the kit that are not received after the surgery.

In another aspect, a system for supplying medical devices is provided that includes a scheduling module that receives user input indicative of a type of a surgery and a location of the surgery and a kit assembly module that generates a first list of components for inclusion in a kit, the first list being generated based on the type of the surgery. The system also includes a returned kit processing module that generates a second list of components returned from the location of the surgery and a billing module that generates billing information comprising charges for components that are listed in the first list and not listed in the second list. In one embodiment, the scheduling module receives surgeon identity information and the kit assembly module generates the list of components based on preference information associated with the surgeon identity information.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic diagram of one exemplary embodiment of a computer system;

FIG. 2 is a schematic diagram of one exemplary embodiment of a surgical support and management system;

FIG. 3 is a screen capture of an exemplary embodiment of a web page for receiving security parameter information from a user;

FIG. 4 is a screen capture of an exemplary embodiment of surgical support and management system web page;

FIG. 5 is a screen capture of the web page of FIG. 4 with a pull-down menu shown in an expanded configuration;

FIG. 6 is a screen capture of an exemplary embodiment of a web page for providing support and/or training information;

FIG. 7 is a screen capture of a web page for implementing at least a portion of a scheduling module; and

FIG. 8 is a screen capture of another web page for implementing at least a portion of a scheduling module.

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Computer System

The systems and methods disclosed herein can be implemented using one or more computer systems, which are also referred to herein as digital data processing systems.

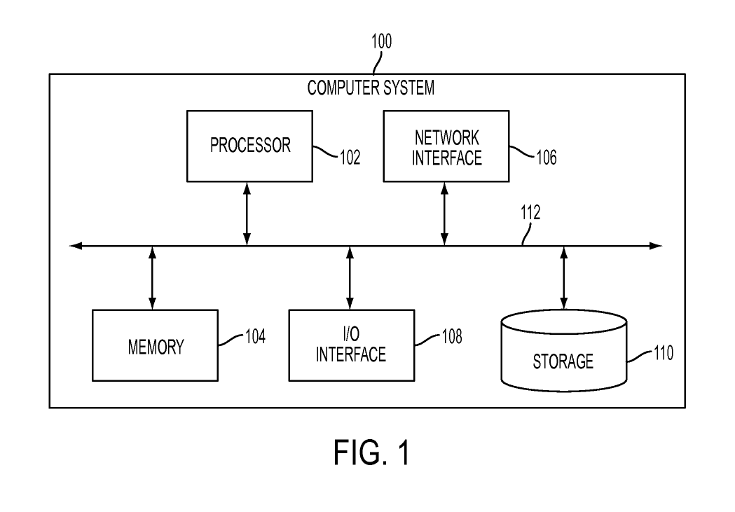

FIG. 1 illustrates one exemplary embodiment of a computer system 100. As shown, the computer system 100 can include one or more processors 102 which can control the operation of the computer system 100. The processor(s) 102 can include any type of microprocessor or central processing unit (CPU), including programmable general-purpose or special-purpose processors and/or any one of a variety of proprietary or commercially available single or multi-processor systems. The computer system 100 can also include one or more memories 104, which can provide temporary storage for code to be executed by the processor(s) 102 or for data acquired from one or more users, storage devices, and/or databases. The memory 104 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 100 can be coupled to a bus system 112. The illustrated bus system 112 is an abstraction that represents any one or more separate physical busses, communication lines/interfaces, and/or multi-drop or point-to-point connections, connected by appropriate bridges, adapters, and/or controllers. The computer system 100 can also include one or more network interface(s) 106, one or more input/output (IO) interface(s) 108, and one or more storage device(s) 110.

The network interface(s) 106 can enable the computer system 100 to communicate with remote devices (e.g., other computer systems) over a network, and can be, for example, remote desktop connection interfaces, Ethernet adapters, and/or other local area network (LAN) adapters. The IO interface(s) 108 can include one or more interface components to connect the computer system 100 with other electronic equipment. For example, the IO interface(s) 108 can include high speed data ports, such as USB ports, 1394 ports, etc. Additionally, the computer system 100 can be accessible to a human user, and thus the IO interface(s) 108 can include displays, speakers, keyboards, pointing devices, and/or various other video, audio, or alphanumeric interfaces. The storage device(s) 110 can include any conventional medium for storing data in a non-volatile and/or non-transient manner. The storage device(s) 110 can thus hold data and/or instructions in a persistent state (i.e., the value is retained despite interruption of power to the computer system 100). The storage device(s) 110 can include one or more hard disk drives, flash drives, USB drives, optical drives, various media cards, and/or any combination thereof and can be directly connected to the computer system 100 or remotely connected thereto, such as over a network. The elements illustrated in FIG. 1 can be some or all of the elements of a single physical machine. In addition, not all of the illustrated elements need to be located on or in the same physical machine. Exemplary computer systems include conventional desktop computers, workstations, minicomputers, laptop computers, tablet computers, PDAs, mobile phones, and the like.

The computer system 100 can include a web browser for retrieving web pages or other markup language streams, presenting those pages and/or streams (visually, aurally, or otherwise), executing scripts, controls and other code on those pages/streams, accepting user input with respect to those pages/streams (e.g., for purposes of completing input fields), issuing HTTP requests with respect to those pages/streams or otherwise (e.g., for submitting to a server information from the completed input fields), and so forth. The web pages or other markup language can be in HTML or other conventional forms, including embedded XML, scripts, controls, and so forth. The computer system 100 can also include a web server for generating and/or delivering the web pages to client computer systems.

While some embodiments are described herein in the context of web pages, it will be appreciated that in other embodiments, one or more of the described functions can be performed without the use of web pages and/or by other than web browser software. A computer system can also include any of a variety of other software and/or hardware components, including by way of non-limiting example, operating systems and database management systems. Although an exemplary computer system is depicted and described herein, it will be appreciated that this is for sake of generality and convenience. In other embodiments, the computer system may differ in architecture and operation from that shown and described here.

Surgical Support and Management System Generally

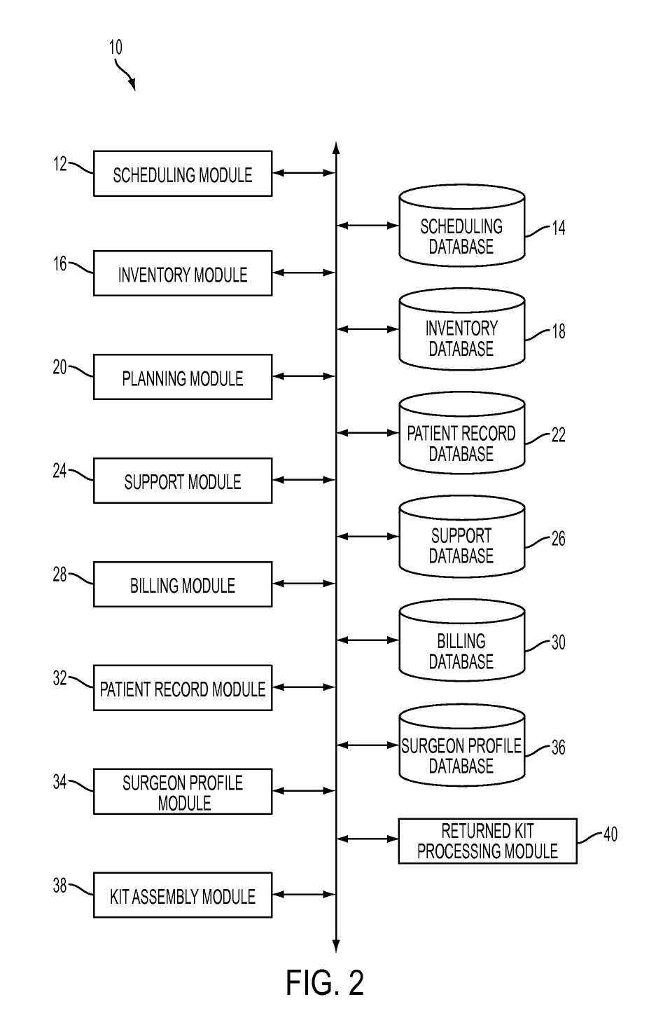

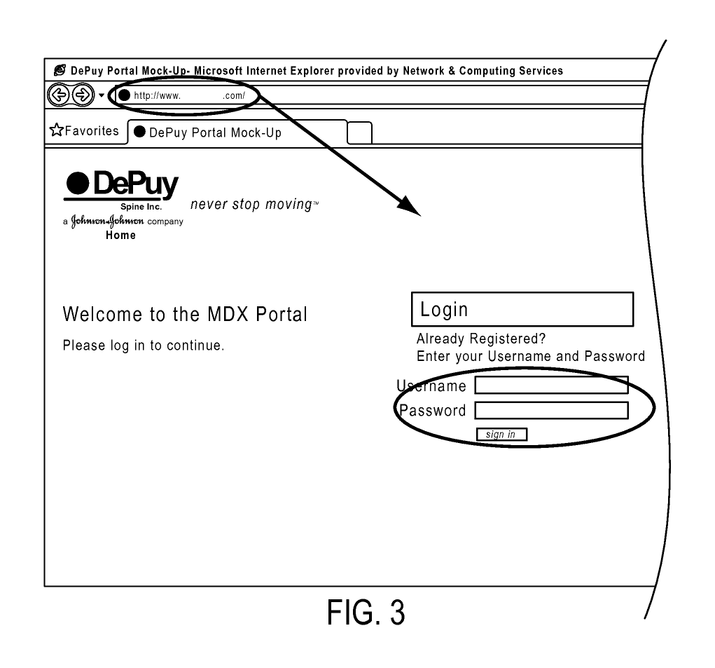

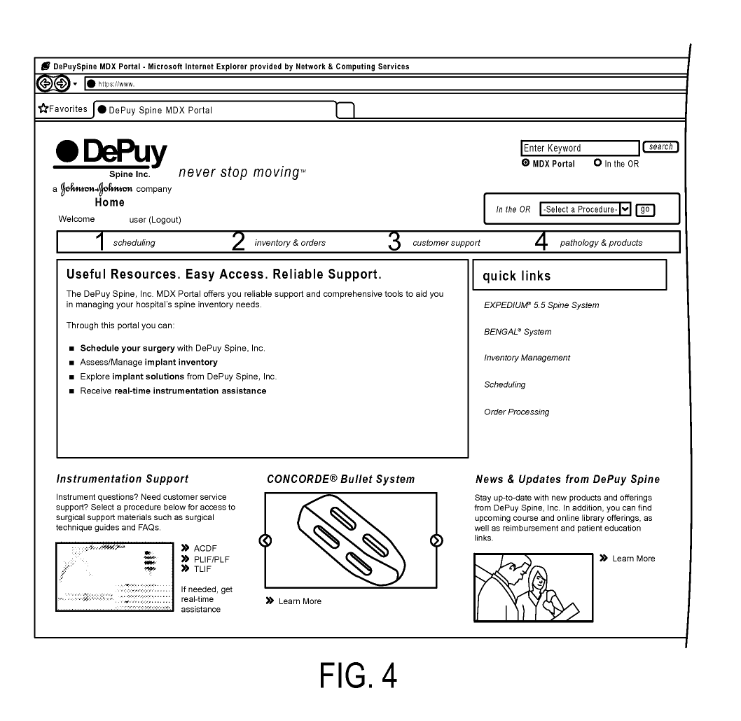

FIG. 2 is a schematic block diagram of one exemplary embodiment of a surgical support and management system 10. As shown, the system 10 includes a plurality of modules, which can each be implemented using one or more digital data processing systems of the type described above, and in particular using one or more web pages which can be viewed, manipulated, and/or interacted with using such digital data processing systems. The system 10 can thus be implemented on a single computer system, or can be distributed across a plurality of computer systems. The system 10 also includes a plurality of databases, which can be stored on and accessed by computer systems. It will be appreciated that any of the modules or databases disclosed herein can be subdivided (e.g., can include one or more separate modules or one or more separate databases) or can be combined with other modules or databases. FIGS. 3-8 show exemplary web page implementations of the system 10, from which web page implementations of one or more of the various modules, or portions thereof, can be accessed.

Any of a variety of parties can access, interact with, control, etc. the system 10 from any of a variety of locations. For example, the system 10 can be accessible from an operating room, a nurse's station, a medical device distribution facility, a medical device company, a hospital's sterilization, records, or billing departments, a patient's home or office, a surgeon's office, a mobile device, and so forth. It will be appreciated that the system 10 can include security features such that the aspects of the system available to any particular user can be determined based on the identity of the user and/or the location from which the user is accessing the system. To that end, each user can have a unique username, password, and/or other security credentials to facilitate access to the system 10. FIG. 3 shows an exemplary web page for receiving security parameter information from a user. The received security parameter information can be checked against a database of authorized users to determine whether the user is authorized and to what extent the user is permitted to interact with the system, view information stored in the system, and so forth. Exemplary parties who can be permitted to access the system 10 include surgical technicians, circulating nurses, scheduling departments, materials managers, operating room directors, billing departments, replenishment departments, and finance departments.

Scheduling Module

The scheduling module 12 can provide users of the system 10 with an interface for scheduling surgeries, cancelling surgeries, viewing already-scheduled surgeries, and/or viewing the availability of surgery-related resources (e.g., hospital equipment, operating rooms, surgical support staff, and surgeons). In one embodiment, the scheduling module 12 is implemented using one or more web pages which are configured to receive user input and present information to a user. In addition, the scheduling module can be configured to read information from and write information to a scheduling database 14.

With the scheduling module 12 of the system 10, surgery schedules can be viewed by a user via a web interface, and can be scheduled using the web interface.

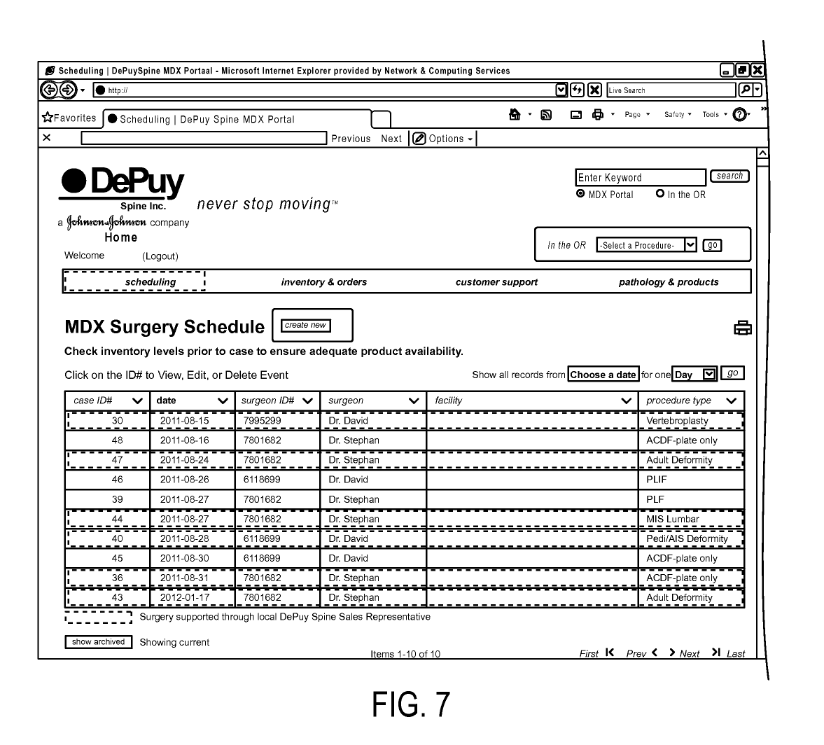

An exemplary web page implementation of the scheduling module 12 in which scheduled surgeries can be viewed is shown in FIG. 7. As shown, the scheduling module 12 retrieves information relating to one or more surgeries from the scheduling database 14 and displays the surgeries in a list. While a list view is shown, any of a variety of other displays can be used, including a calendar view, timeline view, etc. Information relating to each surgery or case is shown in the list. This information includes a case identification number which uniquely identifies each surgery, a date that the surgery is scheduled, a surgeon identification number which uniquely identifies the surgeon assigned to the surgery, a facility at which the surgery is to be performed, and a type of the surgery or procedure. The list of surgeries can be limited by date or any of a variety of other search criteria used to search the scheduling database 14. In addition, the list can be sorted based on any of the categories of information stored in the scheduling database 14.

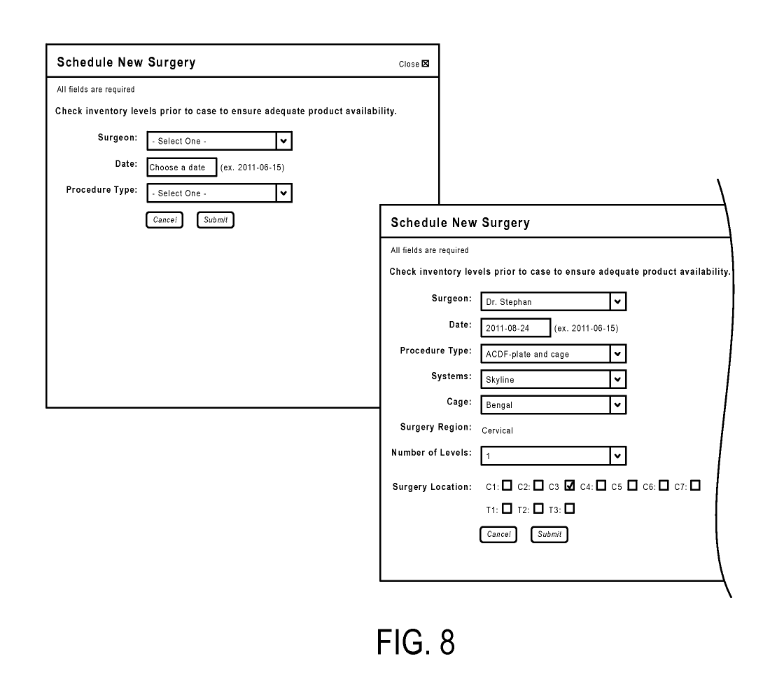

An exemplary web page implementation of the scheduling module 12 in which new surgeries can be scheduled is shown in FIG. 8. This web page can be accessed by selecting the “create new” button shown in FIG. 7. The web page includes fields for selecting a surgeon, a procedure date, and a procedure type. Based on the selected procedure type, the user can be presented with additional fields for selecting the anatomical location of the surgery (e.g., the C4 vertebra of the cervical spine) and the type of implants and/or instruments that are required for the surgery (e.g., a Skyline™ anterior cervical plate system and Bengal® stackable cage system, both available from DePuy Spine, Inc. of Raynham, Mass.). Once the desired information is entered, the web page can store it in the scheduling database 14, such that it appears in the list of surgeries shown to users who access the web page of FIG. 7.

Thus, using the scheduling module 12, a surgeon or member of the surgeon's office can log into the system 10 and specify the date, time, duration, type, patient identifier, and/or various other parameters relating to the surgery. Once entered, this information becomes available to other authorized users of the system 10, such that hospital staff members, surgeons, doctors, nurses, purchasing staff, medical device distributors, medical device companies, etc. can view the surgery schedule. The scheduling module 12 can also be configured to automatically alert one or more parties, send reminders to one or more parties, and/or reserve one or more resources, for example by sending an electronic message or by updating a third party database (e.g., a hospital operating room booking database). Thus, in some embodiments, the scheduling module 12 can automatically send an email to the relevant parties when cases are added to the schedule, or can send reminders at some predetermined interval prior to the surgery, e.g., 48 hours. A user interface of the scheduling module 12 can allow the distribution lists for such emails to be customized by the user. Potential recipients can include schedulers, operating room managers, materials managers, and sales representatives. As described in further detail below, the scheduling module 12 can also interface with other modules of the system 10, for example to allow staff to check inventory levels against scheduled surgeries or to identify a product pick list to be pulled for the surgery.

Inventory Module

The inventory module 16 can provide users of the system with an interface for viewing available inventory, including location, status, expiration date, serial number, lot number, and various other parameters associated with each item of inventory. The inventory module 16 can also allow users to update the status of inventory and order additional inventory. In one embodiment, the inventory module 16 is implemented using one or more web pages which are configured to receive user input and present information to a user. In addition, the inventory module 16 can be configured to read information from and write information to an inventory database 18.

Any of a variety of commercially-available inventory management systems can be used to form portions of the inventory module 16. For example, portions of the inventory module 16 can be implemented using inventory management systems available from WaveMark, Inc. of Littleton, Mass.

With the inventory module 16 of the system 10, hospital inventory and inventory location can be viewed in real-time, for example using one or more web pages. The inventory module 16 can also include a reservation sub-module, which can reserve inventory for upcoming surgeries and automatically order replenishment inventory when inventory is consumed and/or when inventory is reserved.

The inventory module 16 can include provisions for monitoring inventory, ordering additional inventory, generating inventory reports, and managing inventory. For example, the inventory module can be implemented as a web page or a plurality of web pages, which can access the inventory database 18 and determine the status of various items of inventory. The web page can then display an alert when inventory items have expired or will expire in the near future. The web page can also display products that have been reported as missing, damaged, or in need of maintenance or sterilization. The web page can also display open inventory orders that have been pending for more than a predetermined time period, or open inventory orders that do not have a purchase order associated therewith.

The inventory module 16 can also generate an inventory report which can include a list of inventory and various information associated with the inventory. For example, for each item of inventory, the report can display a manufacturer name, general product group, specific product name, product model number, product type, product serial number, product lot code, and/or product expiration date. The report can also indicate, for each item of inventory, the typical quantity of that item inventoried by a particular department (i.e., “Dept Par”), the actual on hand quantity of the item, the difference between the on hand quantity and the typical quantity (i.e., “off Dept Par”), and the location of the item. The reserved status of each item of inventory can also be displayed, for example by displaying a predetermined mark next to inventory that has been reserved by the reservation module. In one embodiment, the predetermined mark can be a “reserved” icon, highlighting of the reserved item, and/or graying out of the reserved item.

The inventory module 16 can also generate a report of inventory that has expired, or that is set to expire in the near future.

The inventory module 16 can also generate an inventory usage report that lists inventory “encounters” (i.e., instances in which the status of an item of inventory is updated, changed, checked, etc.). For each encounter, the report can indicate a unique encounter identifier, the physician or individual associated with the encounter, the location of the encounter, the start time of the encounter, and the quantity of inventory involved in the encounter. The report can also include links to web pages corresponding to each encounter, which can display additional information relating to the encounter to the user. Information relating to each item of inventory, and to each encounter, can be stored in the inventory database 18 by the inventory module 16 and can be retrieved from the inventory database 18 by the inventory module 16 or some other module of the system 10. The inventory database 18 can also be updated using RFID technology or an “on-demand” inventory system, as explained below.

The inventory module 16 can also provide a user interface for ordering inventory (e.g., from a medical device distributor or a medical device company) and for tracking the status of open orders. For example, the inventory module can display a list of pending and/or completed orders, along with various information relating to each order such as the supplier, purchase order number, creation date, and order status. The inventory module 16 can also provide links, buttons, or other interface elements for changing the status of an order, such as for canceling an order, marking an order complete, changing an order quantity, and the like. The inventory module user interface can also include a “smart orders” panel for informing users of newly-released products, pricing specials, or suggested items for purchase. A “catalog” panel can also be included for displaying various manufacturer catalogs and permitting a user to select items from the catalog to add to an existing order or to purchase using a new order.

The inventory module can also include an interface for adding or updating information relating to an encounter to the inventory database 18 (e.g., for creating new encounters, deleting encounters, and changing encounters). The interface can be implemented as a graphical user interface executed using a digital data processing system having, e.g., a touch screen user input device.

The encounter update process can begin by entering an encounter number to retrieve information relating to an encounter that is already stored in the inventory database 18. Alternatively, a doctor name or staff member name can be entered to initiate the process of creating a new encounter. Information relating to an encounter can be retrieved from the inventory database 18 and displayed to the user. In particular, the product name, model number, lot number, expiration date, disposition, and/or status of each item of inventory involved in the encounter can be displayed. A particular item can be selected from the list to view further details relating to that item, such as the item's RFID tag number, manufacturer name, serial number, and division. A user can also change certain information related to each item. In particular, a user can update the disposition of an item to reflect that the item is defective, was wasted, or has been associated with a particular patient (e.g., implanted in the patient or consumed during a surgery performed on the patient). Each time inventory is encountered, a user can access the inventory module 16 to update or check the status of the inventory.

The inventory module 16 can also be configured to update the inventory database 18 automatically, for example upon the occurrence of a triggering event. In one embodiment, the scheduling of a surgery, or updating of a scheduled surgery, by the scheduling module 12 can trigger an inventory update operation by the inventory module 16. During this operation, the inventory module 16 can check to determine whether the inventory required for the surgery is available, for example by checking a quantity field in the inventory database 18 associated with each item. If a sufficient quantity of the item is present in the inventory and not reserved, the reservation module can reserve a quantity of the item required for the surgery. For example, if a particular surgery requires two disc replacement members, and the inventory database 18 indicates that seven disc replacement members are present in the inventory and that only three of the seven are presently reserved, the reservation module can reserve two disc replacement members for the surgery. In one embodiment, this can be accomplished by setting a “reserved” flag in the inventory database 18 for the item or items to be reserved.

If the inventory module 16 determines that there is insufficient inventory on hand for the surgery, it can automatically order additional inventory by creating a new order, as described above. Alternatively, or in addition, an alert can be generated to hospital personnel, who can manually order additional inventory or determine whether inventory reserved for other surgeries can be reallocated.

The inventory module 16 can also be configured to maintain the inventory database 18 in real-time or in substantially real-time. For example, the inventory module can include an RFID system. Each item of inventory can be packaged with an RFID tag that includes an antenna and a unique serial number. This serial number can be used to retrieve additional information about the item of inventory (e.g., its product ID, expiration date, serial number) from one or more databases, which can be included in the system 10 or which can be third-party databases that are accessed by the system 10. Inventory items can be stored in an RFID cabinet that periodically emits radio frequency signals to determine the RFID numbers of each item stored in the cabinet. This information can then be used to update or maintain the inventory database 18 or to trigger an event.

In exemplary embodiments, inventory is removed from the cabinet in advance of a surgery, based on the type of surgery and optionally based upon the surgeon's preferences. The inventory removed from the cabinet is then brought to the operating room for surgery, where consumed product packaging (e.g., including any attached or embedded RFID label) is retained. After the surgery, unused product is returned to the cabinet, which can then determine the quantity and types of product that were consumed or that are missing and update the inventory database 18 accordingly. This update process can also trigger action by the billing module 28, as described below. Alternatively, or in addition, the packaging of the consumed product can be retained so that its disposition can be updated in an encounter, as described above. This can allow a user to map consumed inventory to a particular patient or doctor within the system 10, e.g., for billing or record keeping purposes.

The inventory module 16 can also include a reporting sub-module (e.g., implemented using the encounter system described above), such that inventory that is damaged or missing or in need of repair, maintenance, or sterilization can be flagged. In one embodiment, one or more fields in the inventory database 18 are set or completed by the reporting module when an item status is reported.

When items are marked as having been consumed, or when items are marked as being reserved, the inventory module 16 can be configured to automatically order replenishment inventory to replace the items.

The inventory module 16 can also include an analytics sub-module for collecting, analyzing, and tracking surgery scheduling and inventory consumption information stored in the various databases of the system 10. This information can be categorized to provide users of the system with real time usage data and can drive greater hospital efficiencies with respect to inventory stocking, etc. The analytics module can thus allow a medical device company or its customers to monitor utilization, procedure costs, expiration of inventory, loss of inventory, damaged inventory, frequencies of various types of surgeries, and so forth. The analytics module can also provide “statistical intelligence” features, such as suggesting other products or services that a customer may want to order based on historical inventory and/or scheduling information.

PLANNING MODULE

The system 10 can also include a planning module 20 that allows users of the system to conduct various planning operations (e.g., pre-operative planning, intra-operative planning, post-operative planning, patient education planning, or recovery and rehabilitation planning). In particular, the planning module can include one or more web pages that permit users to upload patient images (e.g., X-rays, CT scans, MRI scans) for storage in a patient record database 22, or for planning of medical devices to be used in a procedure. The planning module 20 can also include one or more web pages that allow users to retrieve and view patient images or other information stored in the patient record database 22, for example in order to determine the number and types of implants or instruments that will be required for a surgery. The planning module 20 can also provide measurement tools or image overlays to facilitate selection and sizing of implants to be used for a particular surgery, based on the patient images. Once such implants or implant sizes are selected, the planning module 20 can communicate with the inventory module 16 to reserve the required implants or to trigger ordering of the required implants.

The planning module 20 can also be configured to schedule or generate a report of follow up appointments, tests, or therapy that should be conducted, which can be determined based on the number and type of implants or instruments used in a surgery and can be stored in the patient record database 22.

Support Module

The system 10 can also include a support module 24 for providing training and support to users of the system 10. In one embodiment, the support module 24 is implemented using one or more web pages which are configured to receive user input and present information to a user. In addition, the support module 24 can be configured to read information from and write information to a support database 26.

With the support module 24 of the system 10, there is no need for a representative to be present in the operating room, particularly for straightforward or routine procedures. Instead, the support module 24 can be configured to provide the required support and training information.

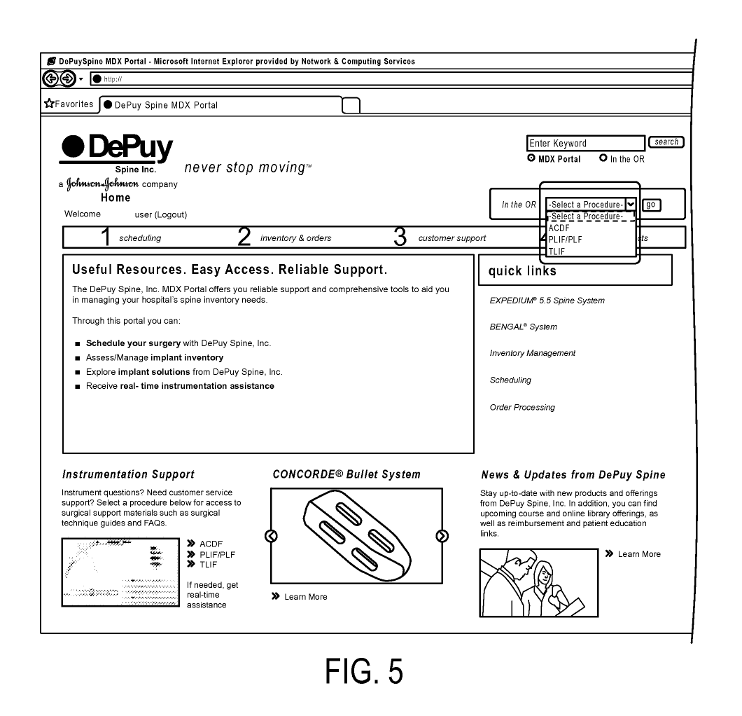

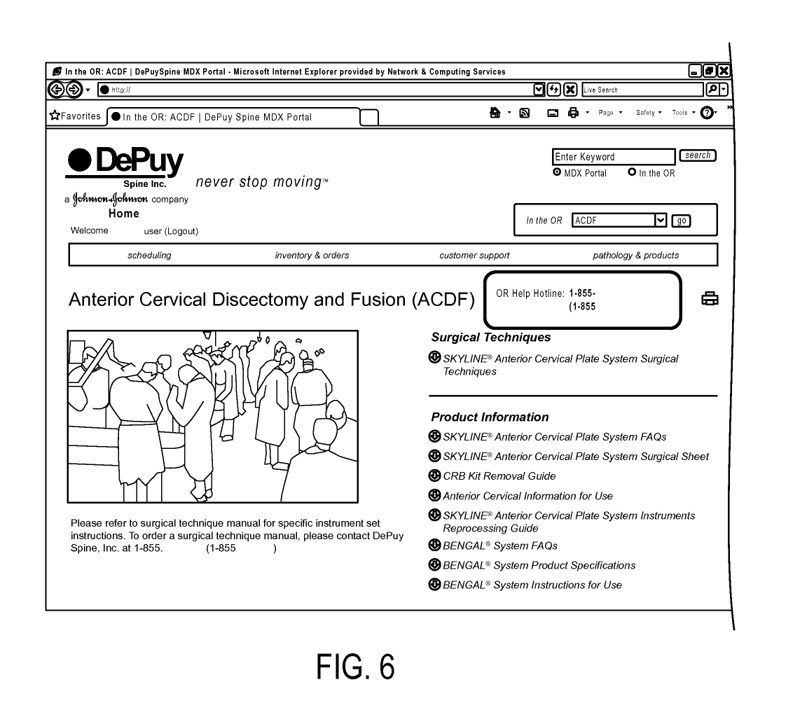

In one embodiment, as shown in FIGS. 5-6, the support module 24 can include one or more web pages for providing support and/or training information, which can be provided before, during, or after a particular surgery or case. In particular, a user can select a type of procedure from a drop down menu on a first web page. Depending on the type of surgery selected, one or more additional web pages can be displayed to the user with links to various digital content stored in the support database 26 or provided by third-parties. Such content can include surgical techniques, instructions for use (IFU) associated with a particular implant or instrument, instructional images, instructional video or audio recordings, product brochures, 3D animations, virtual surgical training tools, surgery notes, and so on. This can allow a user to complete training in advance of a surgery, or to address questions or issues that may arise during the surgery using the system 10. The support module 24 can also include a teleconferencing or videoconferencing feature to facilitate real-time communication between a user and support personnel (e.g., a regional technical support representative of a medical device company). The support module 24 can also provide web-based self help, contact information for a 24-hour support hotline, or for an on-call support representative. In one embodiment, the support module 24 can be accessed from a digital data processing system located within the operating room and can be used during the surgery for training and/or support purposes. The support module 24 can also be configured to request that support personnel be present for a particular surgery or procedure on a fee-for-service, a la carte basis. Thus, a user can use the support module 24 to request that a representative be present for a particular procedure to provide on-site support services for a predetermined fee.

The support module 24 can also be configured to provide support or training materials in response to a triggering event. For example, when a bar code or RFID tag associated with a particular medical device is scanned by the system 10, the support module can automatically provide training materials associated with the scanned medical device.

The support module 10 can be configured to provide patient education information, either before or after a surgery takes place. For example, patients can log into the system 10 to retrieve information regarding pre-operative planning or post-operative care, and/or can opt in to receiving automatic emails containing such information.

Billing Module

The system 10 can also include a billing module 28 for retrieving, displaying, updating, and outputting billing information. In one embodiment, the billing module 28 is implemented using one or more web pages which are configured to receive user input and present information to a user. In addition, the billing module 28 can be configured to read information from and write information to a billing database 30.

With the billing module 28 of the system 10, many if not all of the tasks formerly handled by a representative are performed by the system 10 and/or are completely automated. For example, when a scan of the RFID cabinet described above indicates that inventory has been removed, or when inventory disposition is changed using the encounter system, the billing module 28 can automatically email purchasing staff information regarding the consumed inventory and the corresponding patient number. The purchasing staff can then generate a purchase order that is sent to the medical device company. Alternatively, or in addition, the billing module 28 can store this information in the billing database 30, and can provide one or more web pages for accessing information stored in the database 30. In this way, hospital purchasing staff can log into the system 10, view the billing module web pages, and retrieve billing information from the billing database 30. In one embodiment, consumption of inventory can trigger automatic replenishment by tying directly into the medical device company's order processing systems. In such embodiments, it is not necessarily required that the hospital purchasing staff issue a new purchase order for each replenishment, especially when a blanket purchase order is provided. Instead, the purchasing staff can merely receive notification that a replenishment order was placed. The billing module 28 can thus provide a web-based platform for accurate and streamlined billing, automated charge capture, inventory reconciliation, and automatic replenishment. The billing module 28 can also provide sophisticated usage analytics, automatic, web-based reorders, and traceability.

Patient Record Module

The system 10 can also include patient record module 32 that can include one or more web pages for storing information in the patient record database 22 and retrieving information from the patient record database 22. In one embodiment, the billing module 28 can communicate with the patient record module 32 such that billing information generated upon consumption of inventory is linked to or stored in the patient's records. The patient or the patient's insurance company can later retrieve this information using the patient record module 32. In addition, the inventory module 16 can be configured to store the serial number, lot code, and/or various other information relating to consumed inventory in the patient record database 22. This information can then be accessed using the patient record module 32 during follow up visits, subsequent surgeries, etc. The patient record module can also include one or more layers of security so as to comply with applicable regulations, such as the Health Insurance Portability and Accountability Act (HIPAA) in the United States.

Surgeon Profile Module

The system 10 can also include a surgeon profile module 34 that includes a surgeon profile database 36 and one or more web pages for storing information in the database 36 and retrieving information from the database 36. In one embodiment, the surgeon profile module 34 includes a web page that permits a surgeon or a surgeon's representative to specify preference information corresponding to that surgeon, e.g., based on a particular type of surgery or type of patient. For example, a surgeon may specify a preference that extra bone screws be provided for spinal stabilization procedures performed on pediatric patients, a preference that a particular operating room support professional be present during spinal fusion procedures performed by the surgeon, or a preference that multi-level spinal surgeries only be scheduled during the morning hours. The surgeon profile module 34 can thus permit a surgeon to specify preferences as to particular implant types, brands, sizes, etc. The specified preference information can be associated with the surgeon in the surgeon profile database 36.

This surgeon preference information can then be accessed by other modules of the system 10. For example, the inventory module 16 can determine the surgeon identity and type of procedure for a particular surgery from the scheduling module 12. The inventory module 16 can then refer to surgeon preference information stored in the surgeon profile database 36 to determine what inventory is required for the surgery. The surgeon preference module 34 can also be used by operating room staff or other hospital staff to select the appropriate product to bring to the operating room, thereby minimizing clutter and inventory in the operating room. The surgeon preference module 34 can also be used to minimize the amount of inventory maintained at the hospital, thereby reducing space requirements and minimizing the amount of inventory that the medical device company must deploy to the field.

Post Surgery Logistics

A traditional surgery support and management model required a sales representative of a medical device company to handle inventory sets after each surgery. This required the representative to sort the consumed and unconsumed inventory, to send the inventory and instruments to the hospital's sterilization department, and to assist in restocking the inventory sets.

With the system 10, many if not all of the tasks formerly handled by the representative are performed by the system 10 or other personnel and/or are completely automated. For example, the system 10 can include streamlined set configurations. In other words, rather than providing sets having implants and instruments necessary for any of a broad range of procedure types, small implant and/or instrument sets that are customized for the particular type of surgery can be provided, thereby making it simpler for hospital staff to reassemble the sets. Surgery type information can be retrieved from the scheduling database 14 to determine the makeup of such streamlined sets. Alternatively, or in addition, surgeon preference information can be retrieved from the surgeon profile database 36 to determine the set makeup. The system 10 can also include intuitive set configurations. For example, kits can be provided in a carrying case having uniquely shaped, colored, numbered, or labeled compartments, such that operating room or other staff can sort and restock the kits without assistance from a representative. In addition, the inventory and reporting modules described above can perform the replenishment and inventory flagging operations traditionally performed by the representative or for which the representative traditionally provides assistance.

Inventory Management Models

The system 10 can also support a variety of new models for supporting and managing surgeries and in particular for managing implant and instrument inventory.

One exemplary model is the RFID system described above, in which inventory replenishment and tracking is completed automatically using the inventory module 16 and an associated RFID tag/cabinet system. When a new surgery is scheduled, the required inventory is automatically ordered, or a medical device company or distributor can check hospital inventory using the RFID system to determine what inventory needs to be sent to the hospital. The hospital itself can also check available inventory using such systems.

Another exemplary model is the “on-demand” model. With the on-demand model, the medical device company or a distributor associated therewith receives surgery scheduling information and/or surgeon preference information from the system 10. Based on this information, a kit assembly module 38 then generates a pick list of inventory items (e.g., implants, instruments, or other medical devices) that should be sent to the hospital or other location where the surgery is to be performed. The items can be sterilized or otherwise processed at the medical device company or distributor, such that they can be delivered directly to the operating room without requiring further processing (e.g., sterilization at the hospital). Alternatively, the items can be sterilized at the hospital or site where the surgery is to be performed. After the surgery is completed, the kit is reassembled with any unused items or any items that can be reused. The kit is then returned to the medical device company, at which time a returned kit processing module 40 generates a list of the returned inventory. The billing module 28 of the system 10 then generates billing information for the surgery, for example by comparing the list of inventory provided in the kit to the list of inventory that is returned after the surgery. The system 10 can also be configured to provide a credit to customers when inventory is returned later, after the billing information has already been generated and/or charged to the customer. The returned components can be sterilized or otherwise processed for subsequent use in other kits for other surgeries. Any of a variety of technologies (bar coding, RFID, etc.) can be used to track inventory location through this cycle.

With the on-demand model, sterilized, pre-packaged kits are delivered directly to the hospital. This reduces the sterilization burden on the hospital and the need for a representative of the medical device company to track inventory through the sterilization process and ensure inventory arrives on time for the surgery. Instead, inventory can be tracked and managed from a single location.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A surgical support and management system, comprising:
a scheduling module that maintains a first database of scheduled surgeries, the scheduling module being configured to schedule a surgery by receiving information indicative of a type of the surgery and a time of the surgery and storing the information in the first database; and
an inventory module that maintains a second database of an inventory of medical devices and determines based on the type of the surgery whether a medical device required for the surgery is available in the inventory;
wherein, if the medical device required for the surgery is available in the inventory, the inventory module marks the medical device as being reserved for the surgery in the second database.

2. The system of claim 1, wherein the scheduling module is configured to display one or more of the scheduled surgeries on a calendar.

3. The system of claim 1, wherein the scheduling module is configured to reserve at least one of an operating room, an implant, surgical supplies, surgical equipment, and surgical personnel in response to a surgery being scheduled.

4. The system of claim 1, wherein the scheduling module is configured to send an electronic message to a hospital staff member in response to a surgery being scheduled.

5. The system of claim 1, wherein the inventory module maintains the second database in real-time.

6. The system of claim 1, wherein the inventory module is configured to display a list of items in the inventory and a current location of each item to a user.

7. The system of claim 6, wherein the inventory module is configured to display list entries corresponding to items that are reserved for a surgery with a predetermined mark.

8. The system of claim 1, wherein the inventory module receives inventory quantities and locations from an RFID tracking system.

9. The system of claim 1, wherein the inventory module orders the medical device required for the surgery from a supplier if the medical device required for the surgery is not available in the inventory.

10. The system of claim 1, wherein the inventory module automatically orders at least one of replacements for items of the inventory that are consumed during the surgery and replacements for items of the inventory that are reserved for a surgery.

11. The system of claim 1, further comprising a planning module configured to receive medical images uploaded by a user and to display the uploaded medical images to other users.

12. The system of claim 11, wherein the planning module permits selection of at least one inventory item desired for the surgery and communicates with the inventory module to reserve the at least one inventory item.

13. The system of claim 1, further comprising a support module accessible from an operating room that is configured to display at least one of instructional information and training information to a user.

14. The system of claim 12, wherein the support module comprises a video conferencing interface.

15. The system of claim 12, wherein the support module is configured to provide contact information for support personnel to a user.

16. The system of claim 1, further comprising a billing module that generates electronic billing information corresponding to medical devices used during the surgery.

17. The system of claim 16, wherein the billing module is configured to transfer the electronic billing information to and from at least one of a purchasing department of a surgical facility, a medical device company, and an electronic patient record.

18. The system of claim 1, further comprising a patient record module configured to store at least one of a lot number, a serial number, and an expiration date associated with the medical device in an electronic patient record.

19. The system of claim 1, further comprising a reporting module that receives information from a user indicating that a particular medical device is at least one of damaged, worn, missing, in need of replacement, in need of maintenance, and in need of sterilization, the reporting module storing the information in the second database.

20. The system of claim 1, further comprising a surgeon profile module that stores profile information for each of a plurality of surgeons.

21. The system of claim 20, wherein the profile information for each surgeon comprises, for each of a plurality of types of surgeries, at least one of the surgeon's preferred operating time, the surgeon's preferred support staff, and the surgeon's preferred medical devices.

22. The system of claim 20, wherein the inventory module determines whether sufficient inventory is available based on the surgeon profile information.

23. The system of claim 1, wherein the scheduling module comprises one or more web pages.

24. A surgical support and management method comprising:
electronically maintaining a first database of scheduled surgeries;
using at least one computer system, scheduling a surgery by receiving information indicative of a type of the surgery and a time of the surgery and storing the information in the first database;
electronically maintaining a second database of an inventory of medical devices;
using the at least one computer system, determining based on the type of the surgery whether a medical device required for the surgery is available in the inventory; and
if the medical device required for the surgery is available in the inventory, marking the medical device as being reserved for the surgery in the second database using the at least one computer system.

25-47. (canceled)

48. A method of supplying medical devices, comprising:
electronically receiving surgery information comprising a type of a surgery and a location of the surgery;
using at least one processor coupled to a memory to generate a first list of components for inclusion in a kit, the first list being generated based on the type of the surgery;
assembling the kit and providing the kit to the location of the surgery;
using the at least one processor to generate a second list of unused components received after the surgery; and
using the at least one processor to generate billing information comprising charges for components of the kit that are not received after the surgery.

49. The method of claim 48, further comprising electronically receiving surgeon preference information, wherein the first list is generated based on the surgeon preference information.

50. The method of claim 48, further comprising using the at least one processor to generate credit information when components of the kit are received after the billing information is generated.

51. The method of claim 48, further comprising processing the unused components of the kit for subsequent use.

52. The method of claim 48, wherein the kit is sterilized when provided to the location of the surgery.

53. The method of claim 48, wherein the components comprise sterile implants and sterile instruments.

54. The method of claim 48, wherein the first list is assembled based on received surgeon preference information.

55. The method of claim 48, wherein the surgery information is received via a web portal.

56. The method of claim 48, wherein providing the kit to the location of the surgery comprises shipping the kit directly to the location of the surgery.

57-60. (canceled)
